(19) United States
(12) Patent Application Publication
(10) Pub. No.: US 2007/0229646 A1
(43) Pub. Date: Oct. 4, 2007

(54) Image recording apparatus

(75) Inventors: Hideaki Ogawa, Kyoto (JP); Keisuke Hirayama, Kyoto (JP); Ichiro Watanabe, Kyoto (JP); Hiroyuki Fujisawa, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 11/727,471

(22) Filed: Mar. 27, 2007

(30) Foreign Application Priority Data
Mar. 28, 2006 (JP) 2006-087666
Jan. 25, 2007 (JP) 2007-014656

(51) Int. Cl. B41J 2/375

(52) U.S. Cl. 347/223

(57) ABSTRACT

When rotating a recording drum at low speed, air is jetted from air jet ports toward a point of irradiation, in a direction to diffuse a gas generating from an image recording medium upstream with respect to a direction of rotation of a recording drum. An air curtain approximately semicircular about the point of irradiation is formed upstream thereof with respect to the direction of rotation of the recording drum. As a result, the gas can hardly diffuse from the point of irradiation upstream with respect to the direction of rotation of the recording drum. The gas is collected from a gas suction opening. Thus, the gas is reliably prevented from contacting the image recording medium having an image recorded thereon.

### BACKGROUND OF THE INVENTION

1. Field of the Invention

This invention relates to an image recording apparatus for recording an image on an image recording medium, while rotating a recording drum with an image recording medium mounted peripherally thereof, by moving a recording head in a direction parallel to the axis of the recording drum, and emitting a light beam to the image recording medium.

2. Description of the Related Art

When recording an image with such an image recording apparatus, a gas may generate from the image recording medium. That is, with a heat-sensitive type image recording medium, a gas generates from the image recording medium through a thermal reaction. The gas in this specification should be understood to include not only gas constituents such as sublimates generating from the image recording medium, but also air containing solid components such as dust and ash.

When such a gas enters the recording head, a problem will arise such as fogging of surfaces of an objective lens in the recording head. Moreover, when the gas contacts the image recording medium after an image is recorded thereon, there will arise a problem of deteriorating the recorded image.

Japanese Unexamined Patent Publication No. 2000-56400 describes an image recording apparatus, in which a gas is jetted from an upstream position with respect to a direction of rotation of a recording drum toward adjacent a position where an image recording medium is irradiated by a light beam, and a gas present adjacent the position where the image recording medium is irradiated by the light beam is sucked from a downstream position with respect to the direction of rotation of the recording drum. The image recording apparatus described in this publication, in the modification shown in FIG. 8, additionally jets the gas also from a downstream position with respect to the direction of rotation of the recording drum.

U.S. Pat. No. 5,574,493 describes an image recording apparatus that sucks gas present adjacent a position where a recording medium is irradiated by a light beam.

When a recording drum rotates at high speed, a high-speed airflow is formed along the peripheral surface of the recording drum with the rotation of the recording drum. Therefore, by jetting a gas from an upstream position with respect to the direction of rotation of the recording drum toward adjacent a position where the image recording medium is irradiated by the light beam, and sucking a gas present adjacent the position where the image recording medium is irradiated by the light beam from a downstream position with respect to the direction of rotation of the recording drum, the gas generating in time of image recording can be removed promptly from regions adjacent the recording head and image recording medium.

However, since the airflow formed by rotation of the recording drum has a reduced action when the rotating speed of the recording drum lowers, the gas generating in time of image recording tends to stagnate adjacent the position where the image recording medium is irradiated by the light beam. With the construction in which the gas is jetted from the upstream position with respect to the direction of rotation of the recording drum toward adjacent the position where the image recording medium is irradiated by the light beam, and the gas present adjacent the position where the image recording medium is irradiated by the light beam is sucked from the downstream position with respect to the direction of rotation of the recording drum, the gas will be directed toward of the surface of the image recording medium with an image recorded thereon. This results in a problem of deteriorating the recorded image through contact between the gas and the image recording medium after image recording.

### SUMMARY OF THE INVENTION

The object of this invention, therefore, is to provide an image recording apparatus that can prevent deterioration of a recorded image due to a gas regardless of rotating speeds of a recording drum.

The above object is fulfilled, according to this invention, by an image recording apparatus comprising a recording drum for supporting an image recording medium mounted on a peripheral surface thereof; a rotating device for rotating the recording drum in a first direction about an axis thereof; a recording head for emitting a light beam to the image recording medium mounted on the peripheral surface of the recording drum; a recording head moving device for moving the recording head in a direction parallel to the axis of the recording drum; a jetting device movable with the recording head axially of the recording drum, for jetting a gas from a downstream position with respect to the direction of rotation of the recording drum toward a position of the image recording medium irradiated by the light beam, thereby to diffuse a gas generating from the image recording medium as a result of irradiation by the light beam, upstream with respect to the direction of rotation of the recording drum; and a suction device movable with the recording head axially of the recording drum, for sucking gases present adjacent the position of the image recording medium irradiated by the light beam from an upstream position with respect to the direction of rotation of the recording drum, thereby to suck the gas generating from the image recording medium as a result of irradiation by the light beam and diffused by the jetting device, from the upstream position with respect to the direction of rotation of the recording drum.

This image recording apparatus can effectively prevent deterioration of a recorded image also when the recording drum rotates at low speed.

In a preferred embodiment, a rotating direction changing device is provided for changing the direction of rotation of the recording drum by the rotating device from the first direction of rotation to an opposite direction.

Such an image recording apparatus can effectively prevent deterioration of a recorded image regardless of rotating speeds of the recording drum.

In another preferred embodiment, the rotating speed of the recording drum by the rotating device is selectable from at least two, low and high, speeds; and the rotating direction changing device is arranged, when rotating the recording drum at the low speed, to rotate the recording drum in a direction for enabling the jetting device to diffuse the gas generating from the image recording medium upstream with respect to the direction of rotation of the recording drum, and when rotating the recording drum at the high speed, to rotate the recording drum in a direction for enabling the jetting device to diffuse the gas generating from the image recording medium downstream with respect to the direction of rotation of the recording drum.

In another aspect of the invention, an image recording apparatus comprises a recording drum for supporting an image recording medium mounted on a peripheral surface thereof; a rotating device for rotating the recording drum about an axis thereof; a recording head for emitting a light beam to the image recording medium mounted on the peripheral surface of the recording drum; a recording head moving device for moving the recording head in a direction parallel to the axis of the recording drum; a jetting device movable with the recording head axially of the recording drum, for jetting a gas selectively from one of an upstream position and a downstream position with respect to the direction of rotation of the recording drum toward a position of the image recording medium irradiated by the light beam, thereby to diffuse a gas generating from the image recording medium as a result of irradiation by the light beam, upstream or downstream with respect to the direction of rotation of the recording drum; a suction device movable with the recording head axially of the recording drum, for sucking gases present adjacent the position of the image recording medium irradiated by the light beam selectively from one of an upstream position and a downstream position with respect to the direction of rotation of the recording drum, thereby to suck the gas generating from the image recording medium as a result of irradiation by the light beam and diffused by the jetting device, from the one of the upstream position and the upstream position with respect to the direction of rotation of the recording drum; and a jetting/sucking direction changing device for changing a gas jetting direction of the jetting device and a gas sucking direction of the suction device, as maintained counter to each other.

Other features and advantages of the invention will be apparent from the following detailed description of the embodiments of the invention.

### BRIEF DESCRIPTION OF THE DRAWINGS

For the purpose of illustrating the invention, there are shown in the image recordings several forms which are presently preferred, it being understood, however, that the invention is not limited to the precise arrangement and instrumentalities shown.

FIG. 1A is an explanatory view illustrating a basic concept of this invention;

FIG. 1B is an explanatory view illustrating the basic concept of this invention;

FIG. 2 is a schematic view of an image recording apparatus in a first embodiment of this invention;

FIG. 3 is an exploded perspective view of a recording head used in the image recording apparatus;

FIG. 4 is a schematic view showing a principal electrical structure of the image recording apparatus along with a recording drum, a second suction unit and the recording head;

FIG. 5 is an explanatory view graphically showing functions of a controller and a table;

FIG. 6 is a functional block diagram of the controller and table;

FIG. 7 is a conceptual diagram illustrating airflow around the recording head in the image recording apparatus;

FIG. 8 is a sectional view of the second suction unit;

FIG. 9 is a perspective view of a gas diffusing suction unit;

FIG. 10 is a front view of the gas diffusing suction unit;

FIG. 11 is a view in vertical section of the gas diffusing suction unit;

FIG. 12 is a flow chart of an image recording operation;

FIG. 13A is an explanatory view illustrating a modification of the image recording apparatus in the first embodiment;

FIG. 13B is an explanatory view illustrating the modification of the image recording apparatus in the first embodiment;

FIG. 14 is a schematic view of an image recording apparatus in a second embodiment of this invention;

FIG. 15 is a schematic view of an image recording apparatus in a further embodiment of this invention; and

FIG. 16 is a graph showing a relationship between rotating speed of the recording drum and transmission density of an image recording medium with an image recorded then.

### DESCRIPTION OF THE PREFERRED EMBODIMENTS

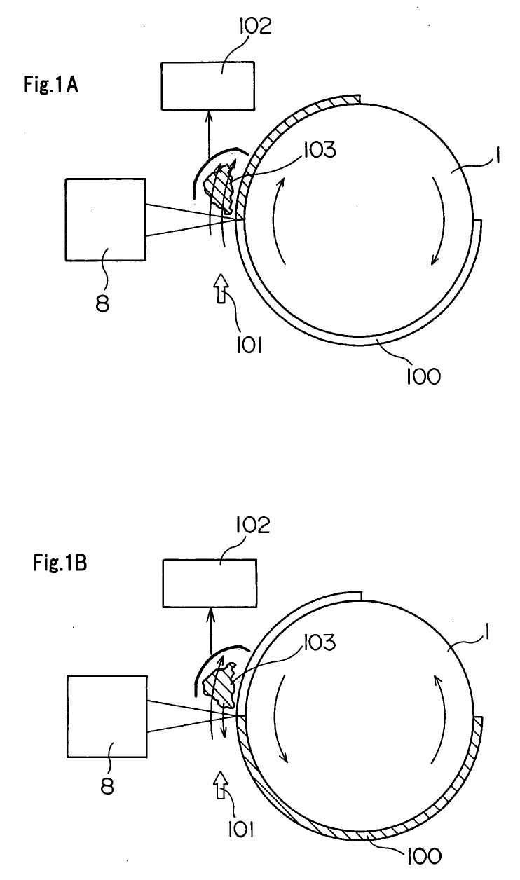

The basic concept of this invention will be described first. FIGS. 1A and 1B are explanatory views illustrating the basic concept of this invention.

In these figures, numeral 100 schematically denotes an image recording medium mounted peripherally of a recording drum 1. Numeral 101 denotes a clean gas (e.g. ambient air around the image recording apparatus) jetted out by a gas jetting mechanism. Numeral 102 denotes a suction mechanism. Numeral 103 denotes a gas generated by a light beam emitted from a recording head 8.

As shown in FIG. 1A, when an image is recorded with the recording drum 1 rotated at high speed, an airflow is produced around the recording drum 1 by rotation of the recording drum 1. Therefore, as shown in FIG. 1A, the gas is jetted from an upstream position with respect to the direction of rotation of the recording drum 1 toward adjacent a position where the image recording medium 100 is irradiated by the light beam. As the gas present adjacent the position where the image recording medium 100 is irradiated by the light beam is sucked from a downstream position with respect to the direction of rotation of the recording drum 1, the gas is promptly sucked and discharged by actions of the airflow and gas jetting and suction.

With such an image recording apparatus, it may be necessary to record an image with the recording drum 1 rotated at low speed, depending on the sensitivity of the image recording medium 100, power of a laser source in the recording head 8, resolution in time of image recording, and so on. In such a case, hardly any airflow is produced around the recording drum 1 by rotation of the recording drum 1. It is difficult to discharge the gas generating in time of image recording to a satisfactory extent only by actions of the gas jetting and suction. The gas tends to stagnate adjacent the position where the image recording medium 100 is irradiated by the light beam.

With the construction in which the gas is jetted from the upstream position with respect to the direction of rotation of the recording drum toward adjacent the position where the image recording medium is irradiated by the light beam, and the gas present adjacent the position where the image recording medium is irradiated by the light beam is sucked from the downstream position with respect to the direction of rotation of the recording drum, the gas will be directed toward of the surface of the image recording medium with an image recorded thereon. This results in a problem of deteriorating the recorded image through contact between the gas and the image recording medium after image recording.

Therefore, when the recording drum 1 is rotated at low speed as noted above, it is desirable to reverse the direction of rotation of the recording drum 1 from clockwise rotation shown in FIG. 1A to counterclockwise rotation shown in FIG. 1B. In this case, the gas is jetted from a downstream position with respect to the direction of rotation of the recording drum 1 toward adjacent the position where the image recording medium 100 is irradiated by the light beam, and the gas present adjacent the position where the image recording medium 100 is irradiated by the light beam is sucked from an upstream position with respect to the direction of rotation of the recording drum 1.

Since hardly any airflow is produced around the recording drum 1 by rotation of the recording drum 1 in this case, the gas is sucked and discharged by actions of the gas jetting and suction. Even if the gas should stagnate adjacent the position where the image recording medium is irradiated by the light beam, the gas would be directed toward of the surface of the image recording medium before an image is recorded thereon because of the construction in which the gas is jetted from the downstream position with respect to the direction of rotation of the recording drum 1, and the gas is sucked from the upstream position with respect to the direction of rotation of the recording drum 1. No contact occurs between the gas and the image recording medium after image recording. Thus, the recorded image is free from deterioration.

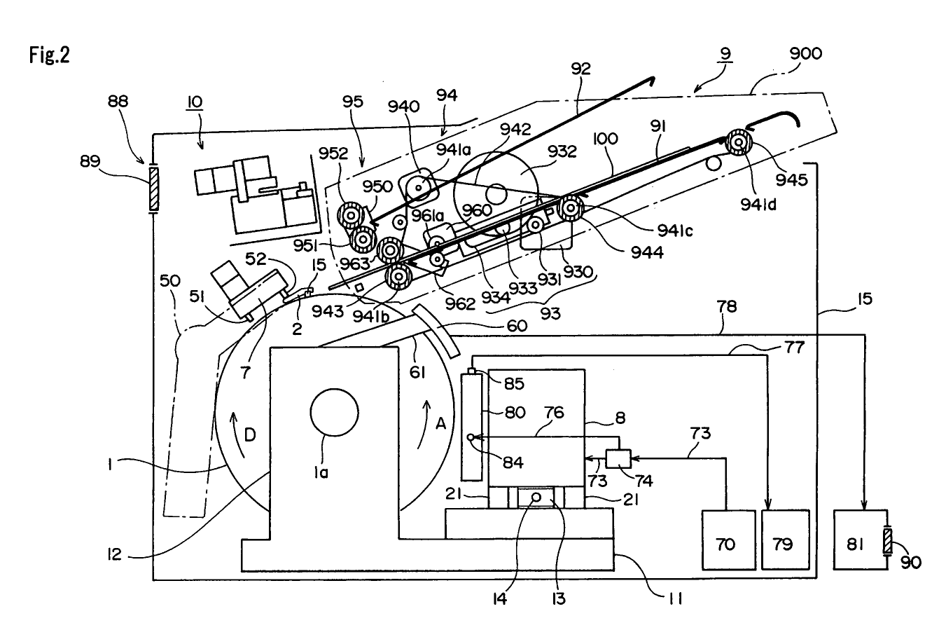

In this way, the relationship between the direction of rotation of the recording drum 1 and the gas jetting and sucking direction is reversed according to the rotating speed of the recording drum 1. It is possible as a result to effectively prevent deterioration of the recorded image caused by the gas, regardless of rotating speeds of the recording drum Next, an embodiment of this invention will be described with reference to the drawings. FIG. 2 is a schematic view of an image recording apparatus in the first embodiment of this invention.

The image recording apparatus includes a cylindrical recording drum 1, a recording head 8, a transport unit 9, a punching device 10, a base 11, an air supply pump 70, a first vacuum pump 79 and clamp arms 50 arranged in a housing 15 having an air intake 88 formed therein. A filter 89 is detachably attached to the air intake 88 of the housing 15.

The recording drum 1 is mounted to be rotatable about a rotary shaft 1a relative to bearings 12 arranged on the base 11 in the housing 15 of the image recording apparatus. The recording drum 1 is rotatable in the direction of arrow A or in the direction of arrow D by a motor 120 described hereinafter.

An image recording medium 100 is mounted peripherally of the recording drum 1. This image recording medium 100 is, for example, a printing plate with a photosensitive material coated on an aluminum base. An image recording medium formed of resin for making a flexographic printing plate or intaglio printing plate can be used as the image recording medium 100.

One end of the image recording medium 100 is fixed to the peripheral surface of the recording drum 1 by a plurality of forward end clamps 2 arranged on the peripheral surface. The other end of the image recording medium 100 is fixed to the peripheral surface of the recording drum 1 by a plurality of rear end clamps 3 (not shown in FIG. 2) detachably attached to the peripheral surface.

The recording head 8 is disposed on a pair of rails 21 forwardly of the recording drum 1. The recording head 8 is meshed with a feed rod 14 rotatable by a motor 13, to be movable parallel to the rotary shaft of the recording drum 1.

This image recording apparatus has a pair of right and left clamp arms 50. A drive bar 7 is attached between the clamp arms 50. The clamp arms 50 are rockable in directions for moving the drive bar 7 toward and away from the recording drum 1. The drive bar 7 has drive pins 51 for fixing and removing the rear end clamps 3 to/from the recording drum 1, and release pins 52 for releasing the forward end clamps 2 when attaching the image recording medium 100.

The transport unit 9 is rockably disposed above the recording drum 1. The transport unit 9 has a first transport path 91 for feeding image recording media 100, and a second transport path 92 for discharging image recording media 100. When feeding the image recording media 100, the image recording media 100 are fed to the recording drum 1 through the first transport path 91 of the transport unit 9. When discharging the image recording media 100, the image recording media 100 detached from the recording drum 1 are transported through the second transport path 92 of the transport unit 9 out of the image recording apparatus.

A first transport mechanism 94 includes a transport roller drive motor 940, a plurality of transport rollers 943, 944 and 945, a belt pulley 941a connected to the transport roller drive motor 940, belt pulleys 941b, 941c and 941d connected to the respective transport rollers 943, 944 and 945, a belt 942 wound on the belt pulleys 941a, 941b, 941c and 941d, a nip roller 963 disposed opposite the transport roller 943, a rocking member 962 having the nip roller 963 attached to a distal end thereof, and a nip roller drive motor 960 for rocking the rocking member 962 to move the nip roller 963 toward and away from the transport roller 943.

A second transport mechanism 95 includes a transport roller drive motor 950, and transport rollers 951 and 952 driven by the motor 950.

A transport path switching mechanism 93 includes a transport path switching motor 930, a gear 931, a cam gear 932, a cam follower 933 and a cam follower guide 934. The gear 931 is attached to the transport path switching motor 930, the cam gear 932 is meshed with the gear 931, and the cam follower 933 is fixed to the cam gear 932. The cam follower 933 is engaged with the cam follower guide 934. The cam follower guide 934 is fixed to a main unit body 900 which is supported by a predetermined support element to be rockable about its rear position relative to the housing 15.

Rotation of the transport path switching motor 930 rotates the cam gear 932 through the gear 931, and the cam follower 933 fixed to the cam gear 932 moves the cam follower guide 934 up and down. As a result, the transporting unit 9 rocks between a position opposed to the punching device 10 and a position opposed to the drum 1.

The punching device 10 is disposed adjacent a forward end of the transport unit 9 for forming positioning holes in the image recording medium 100 for use by the recording drum 1 and a printing machine. Before being fed to the recording drum 1, the image recording medium 100 is fed to the punching device 10 through the first transport path 91 of the transport unit 9, where positioning holes for use by the recording drum 1 and the printing machine are formed in a forward end region of the image recording medium 100. The positioning holes of the image recording medium 100 for the recording drum 1 are engageable with positioning pins 15 arranged on the peripheral surface of the recording drum 1.

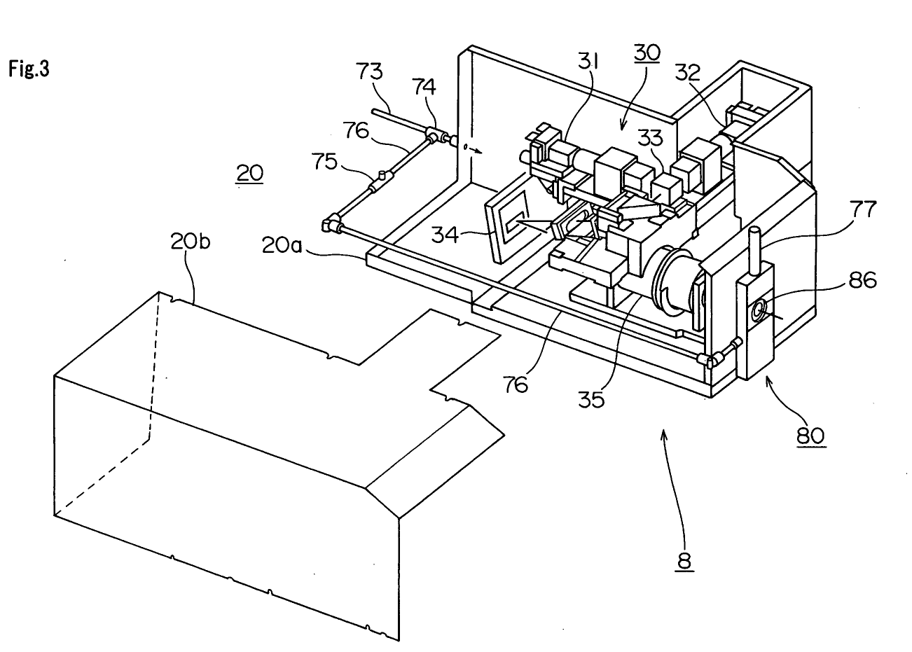

The recording head 8 has, mounted therein, a laser source 30 (FIG. 3) described hereinafter. The laser source 30 is controlled in response to image signals to emit a light beam toward the image recording medium 100 fixed to the peripheral surface of the recording drum 1. The motor 13 moves the recording head 8 in the direction (secondary scanning direction) parallel to the rotary shaft 1a of the recording drum 1 synchronously with rotation of the recording drum 1, to form a desired two-dimensional image on the image recording medium 100 mounted on the recording drum 1.

This image recording apparatus uses the image recording medium 100 such as a thermal plate (image recording medium) undergoing heat mode variations by irradiation of a high power light beam, for example. A gas is generated from this image recording medium 100 by irradiation of the light beam. It is undesirable from the viewpoint of maintenance and control of the apparatus for this gas to adhere to various components of the recording head 8, transport unit 9 and punching device 10 arranged in the housing 15. The recorded image is deteriorated when this gas contacts the image recording medium 100 after image recording.

In order to prevent such inconveniences, this image recording apparatus includes a gas diffusing suction unit 80 disposed on a front surface of the recording head 8, and a second suction unit 60 disposed between the recording head 8 and transport unit 9 and elongated in the direction parallel the rotary shaft of the recording drum 1. The second suction unit 60 has a suction opening shaped generally to follow the peripheral surface of the recording drum 1, and is fixed to the bearings 12 by a pair of support arms 61.

The air supply pump 70 serves to feed air from outside the housing 15 of the image recording apparatus into a feed pipe 73 after cleaning the air through a predetermined filter. The feed pipe 73 is in communication with the recording head 8 to pressurize the interior of the recording head 8. This lowers the possibility of ambient air entering the recording head 8. The feed pipe 73 is connected to a second feed pipe 76 by a branch pipe 74. The second feed pipe 76 is connected to the gas diffusing suction unit 80 at an air supply port 84, through which to supply the air to the gas diffusing suction unit 80.

The first vacuum pump 79 exhausts gas from the gas diffusing suction unit 80 through a gas collecting port 85, and discharges the gas outside the housing 15 after cleaning the gas through a predetermined filter.

FIG. 3 is a perspective view illustrating a detailed construction of the recording head 8. The recording head 8 has a case 20, the laser source 30 disposed inside the case 20, and the gas diffusing suction unit 80 attached to a front surface of the case 20.

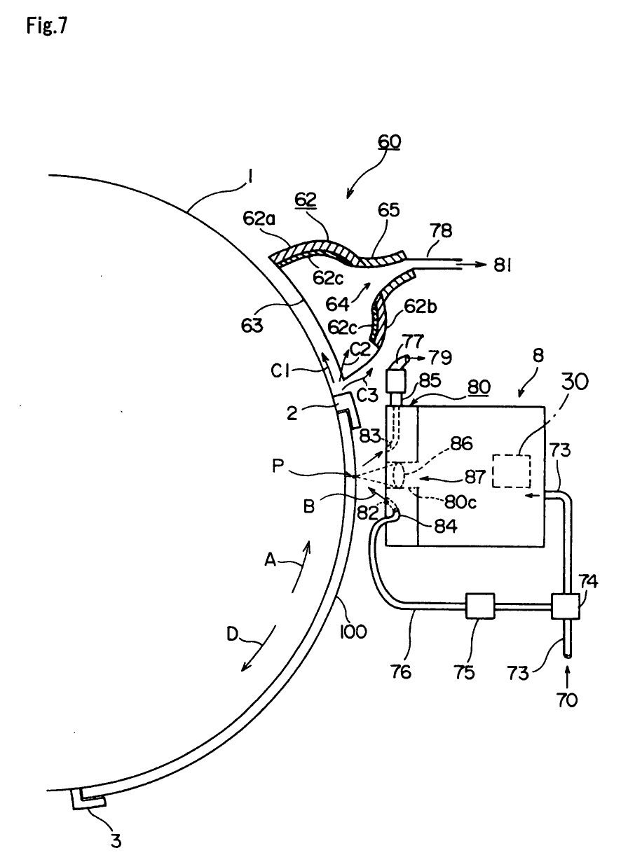

The case 20 is a gastight container, and consists of a lower case 20a and an upper case 20b. The lower case 20a and upper case 20b are combined so that the laser source 130 is shielded gastight against the atmosphere inside the housing 15 of the image recording apparatus. A laser emitting bore 87 (FIG. 7) is formed in a surface of the lower case 20a opposed to the recording drum 1.

The laser source 30 is disposed on a bottom surface of the lower case 20a. The laser source 30 includes two laser units 31 and 32, a synthesizer 33 for synthesizing two laser beams emitted from the laser units 31 and 32, a modulator 34 for selectively reflecting the synthesized laser light in response to image signals, and imaging optics 35 for focusing the laser light reflected from the modulator 34 on the image recording medium 100 through the laser emitting bore 87 and an objective lens 86.

The recording head 8 is supplied with air from the feed pipe 73. The feed pipe 73 is connected to the recording head 8 at a back surface of the recording head 8. The feed pipe 73 is connected in an intermediate position thereof to the second feed pipe 76 by the branch pipe 74. The second feed pipe 76 is a pipe for supplying air to the gas diffusing suction unit 80 disposed on the front surface of the recording head 8. The air feed rate to the gas diffusing suction unit 80 is adjusted by a regulating valve 75.

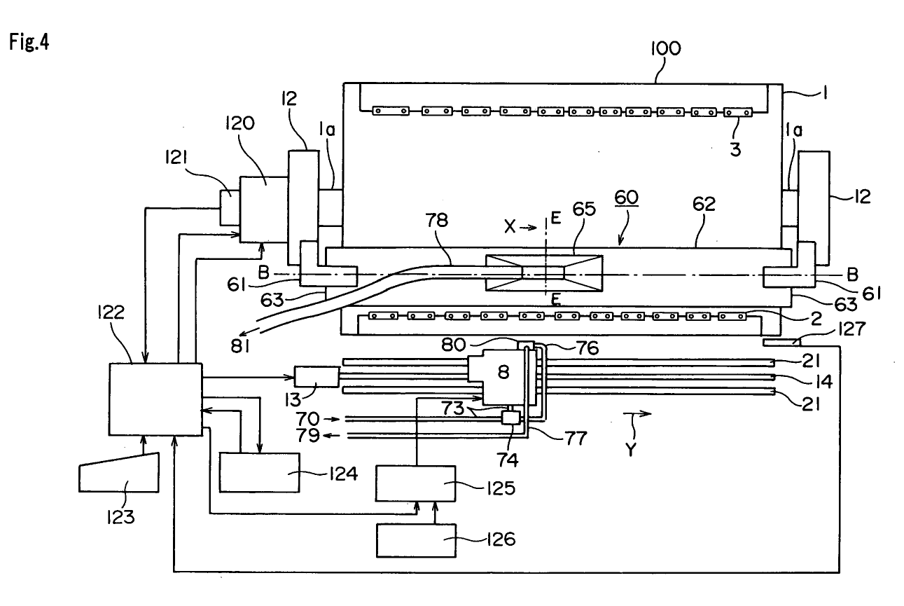

An electric structure of the image recording apparatus will be described next. FIG. 4 is a schematic view showing a principal electrical structure of the image recording apparatus along with the recording drum 1, second suction unit 60 and recording head 8.

As shown, the recording drum 1 is supported by the bearings 12 to be rotatable about the rotary shaft 1a, and is driven by the motor 120 to rotate in opposite directions. As described hereinafter, the motor 120 can rotate the recording drum 1 at various speeds under control of the controller 122. The recording drum 1 may be rotated at a speed selected from at least two rotating speeds, i.e. high speed and low speed. An actual rotating speed of the recording drum 1 is detected by a rotary encoder 121. The rotary encoder 121 transmits a result of detection as rotating speed information on the recording drum 1 to the controller 122 which controls the entire apparatus.

The controller 122 is connected to an input device 123. The input device 123 is used for inputting data such as the type of image recording medium 100 mounted peripherally of the recording drum 1, and resolution in time of image recording.

The controller 122 is connected also to a table 124. The table 124 stores image recording conditions corresponding to each image recording medium 100. The image recording conditions include rotating speeds and directions of rotation of the recording drum 1.

The controller 122 is connected also to a recording head drive circuit 125 for controlling the recording head 8. The recording head drive circuit 125 is connected to an image data memory 126. The image data memory 126 stores image data to be recorded on the image recording medium 100. Under control of the controller 122, the recording head drive circuit 125 reads image data from the image data memory 126 according to a direction of data reading based on a direction of rotation of the recording drum 1, and a rotating speed of the recording drum 1, and feeds this data to the recording head 8.

Further, the controller 122 is connected to an actinometric sensor 127. The actinometric sensor 127 is disposed in a position sideways from an image recording area, and is movable to a position opposed to the objective lens 86 of the recording head 8. The actinometric sensor 127 serves to measure intensity of the light beam emitted from the recording head 8.

The controller 122 determines a rotating speed and a direction of rotation of the recording drum 1 in time of image recording, based on data of the type of image recording medium 100, resolution in time of image recording and so on inputted from the input device 123, image recording conditions read from the table 124, and the quantity of light measured by the actinometric sensor 127. The controller 122 functions as the rotating direction changing device, jetting direction changing device and sucking direction changing device of this invention.

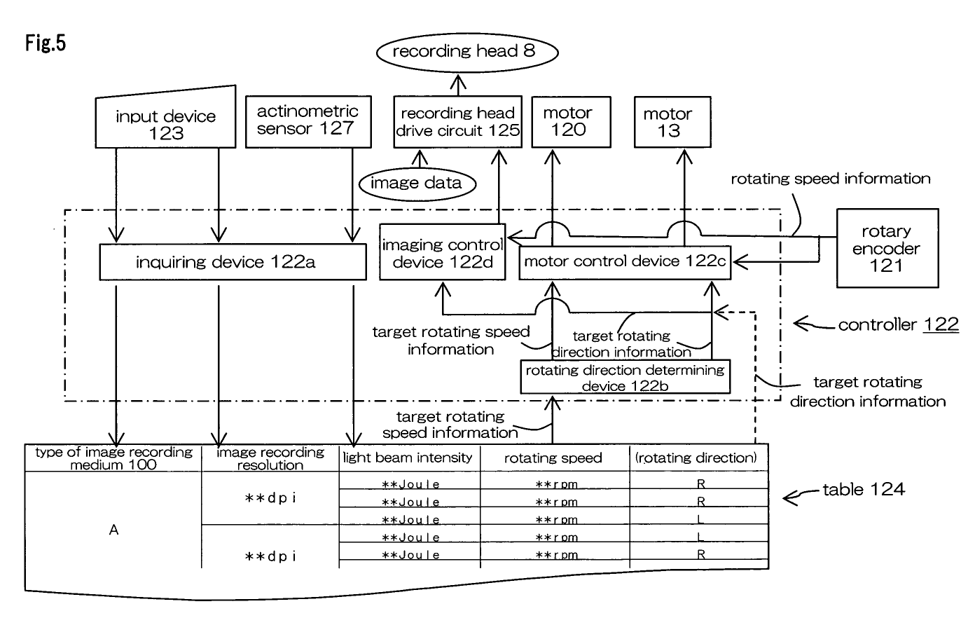

FIG. 5 is an explanatory view graphically showing functions of the controller 122 and table 124.

The rotating speed of the recording drum 1 needs to be set to a primary scanning speed for recording a desired image on the image recording medium 100. The image recording medium 100 has sensitivity varying from type to type. It is therefore necessary to determine a primary scanning speed by taking into account the sensitivity of image recording medium 100 to be used. A spot size of the light beam is changed according to the resolution in time of image recording, and energy density per unit area of the light beam is also changed accordingly. Therefore, when determining a primary scanning speed (rotating speed of the recording drum 1), it is necessary to take into account also the resolution in time of image recording. For the same reason, it is necessary, in determining a primary scanning speed, to take into account also the intensity of the light beam actually emitted from the recording head 8.

Primary scanning speeds (=rotating speeds of the recording drum 1) that can secure predetermined image quality are determined beforehand by considering the above three factors (type of image recording medium 100, resolution in time of image recording, and intensity of the light beam) in a comprehensive way, and stored in the table 124.

After a rotating speed of the recording drum 1 is determined, a direction of rotation of the recording drum 1 is determined for effectively collecting the gas generating from the image recording medium 100. At this time, a determination may be made with increased propriety by taking into account the attributes of the gas generating from the image recording medium 100. In this case, a direction of rotation of the recording drum 1 is determined by taking into account not only the rotating speed of the recording drum 1 but also the type of image recording medium 100.

As described hereinbefore with reference to FIGS. 1A and 1B, the recording drum 1 is rotated in the direction shown in FIG. 1A in time of high-speed rotation, and in the direction shown in FIG. 1B in time of low-speed rotation. A direction of rotation of the recording drum 1 can be selected by using a predetermined rotating speed as a threshold. When the rotating speed is at or above the threshold, the recording drum 1 is rotated in the direction shown in FIG. 1A. That is, the recording drum 1 is rotated in the same direction as the airflow formed by the gas jetting device 101 and suction mechanism 102. Conversely, when the rotating speed is below the threshold, the recording drum 1 is rotated in the direction shown in FIG. 1B. That is, the recording drum 1 is rotated in the direction counter to the airflow formed by the gas jetting device 101 and suction mechanism 102.

This threshold can be varied by taking into account the attributes of the gas generating from the image recording medium 100 (e.g. specific gravity, temperature, and a degree of influence on a recorded area of the image recording medium 100). Where, for example, the generating gas has a significant influence on the recorded area of the image recording medium 100, the above threshold should desirably be set somewhat low. Conversely, where the generating gas has little influence on the recorded area, the above threshold should desirably be set somewhat high. In this way, a direction of rotation of the recording drum 1 may be determined with increased propriety by taking into account not only the rotating speed of the recording drum 1 but the type of image recording medium 100.

Further, a direction of rotation of the recording drum 1 may be determined with increased propriety also by taking the resolution in time of image recording into account. In this case, a direction of rotation of the recording drum 1 is determined by taking into account not only the rotating speed of the recording drum 1 but the resolution in time of image recording. For example, since a precise image is formed when image recording is carried out at high resolution, generally the gas is considered to have a strong influence on an image-bearing area. It is therefore desirable to set the above threshold somewhat low when recording an image at high resolution. On the other hand, since an image formed at low resolution is not so precise, generally the gas is considered to have little influence on the image-bearing area. It is therefore desirable to set the threshold somewhat high when recording an image at low resolution.

Based on the above concept, the table 124 has, recorded as matched beforehand, combinations of the types of image recording medium, resolutions in time of recording and intensities of the light beam, and combinations of rotating speeds and directions of rotation of the recording drum 1.

It is also possible to determine a direction of rotation of the recording drum 1 uniformly by comparing the rotating speed of the recording drum 1 with a fixed threshold, without considering the nature of the gas generating from the image recording medium 100 and resolution in time of image recording. In this case, it is not absolutely necessary to store the directions of rotation of the recording drum 1 in the table 124. The controller 122 may determine a direction of rotation of the recording drum 1 based on the rotating speed and the above threshold read from the table 124.

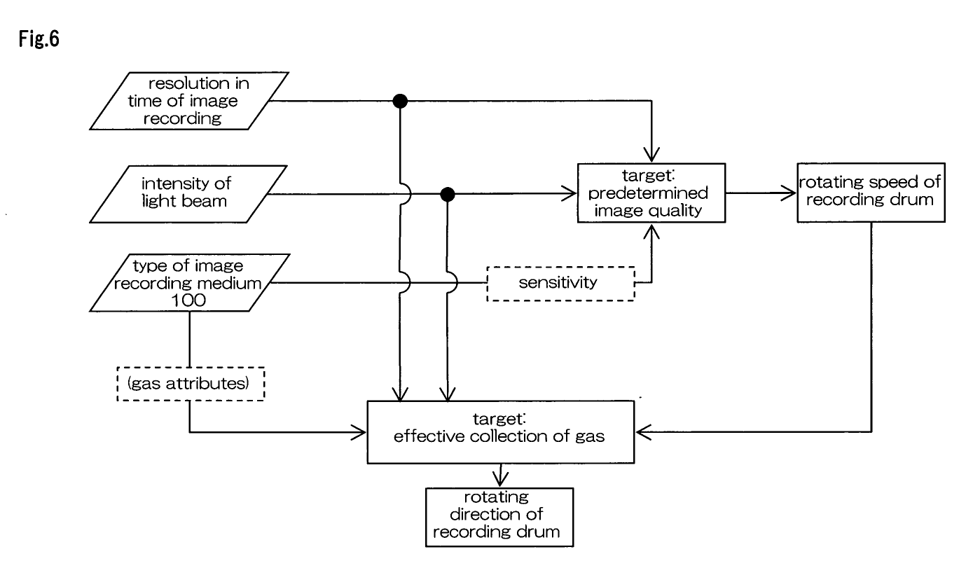

FIG. 6 is a functional block diagram illustrating functions of the controller 122 and table 124. Detailed functions will be described with reference to FIG. 6.

The table 124 receives, as input items, the types of image recording medium 100, resolutions in time of recording, and intensities of the light beam, and outputs image recording conditions including a rotating speed (target rotating speed information) and a direction of rotation (target rotating direction information) of the recording drum 1. The table 124 stores the target rotating speed information and target rotating direction information as matched with the combinations of the types of image recording medium 100, resolutions in time of recording and intensities of the light beam. As noted hereinbefore, the directions of rotation of the recording drum 1 need not be recorded beforehand in the table 124.

The controller 122, specifically, includes an inquiring device 122a for accessing the table 124 to inquire about data, a rotating direction determining device 122b for determining a direction of rotation of the recording drum 1 based on the target rotating speed information read from the table 124 (the device 122b being dispensable when target rotating direction information is stored in the table 124), a motor control device 122c and an imaging control device 122d.

The motor control device 122c sets a direction of rotation of the motor 120 based on the direction of rotation determined by the rotating direction determining device 122b (or on the target rotating direction information read from the table 124), and controls the motor 120, by referring to the rotating speed information provided by the rotary encoder 121, to rotate recording drum 1 at a rotating speed corresponding to the target rotating speed information read from the table 124. At the same time, the motor control device 122c controls the motor 13 to move the recording head 8 in the secondary scanning direction at a speed synchronized with the rotating speed of the recording drum 1.

The imaging control device 122d controls the recording head drive circuit 125 to read image data from the image data memory 126 in a direction corresponding to the direction of rotation of the recording drum 1, and to read the image data from the image data memory 126 at a speed synchronized with the rotating speed of the recording drum 1 by referring to the rotating speed information.

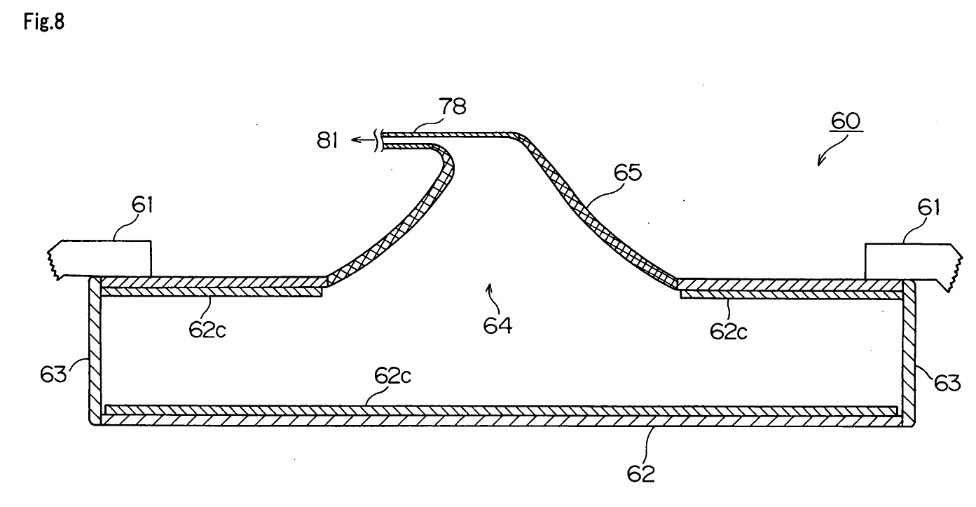

The second suction unit 60 will be described next. FIG. 7 is a side view showing the recording head 8 and adjacent components, including a section of the second suction unit 60 taken on line E-E of FIG. 4. FIG. 8 is a sectional view of the second suction unit 60 taken on line B-B of FIG. 4 and seen from the recording head 8.

As shown in FIGS. 4, 7 and 8, the second suction unit 60 includes a unit main body 62 elongated axially of the recording drum 1 and having a shape of a part cylinder, a pair of side plates 63 closing the sides of the unit main body 62, an opening 64 formed in an upper surface of the unit main body 62 and elongated axially of the recording drum 1, and a taper portion 65 connected to the opening 64.

As shown in FIG. 4, the second suction unit 60 has a length axially of the recording drum 1 greater than the axial length of the recording drum 1. Naturally, therefore, the second suction unit 60 is longer in this direction than the image recording medium 100 mounted on the recording drum 1. The second suction unit 60 is longer in this direction than a movable range of the recording head 8 also. Consequently, wherever the recording head 8 is in the secondary scanning direction, the second suction unit 60 is present in a position opposed to the gas generating from the image recording medium 100 as a result of irradiation by the light beam emitted from the recording head 8. While, in this embodiment, the second suction unit 60 is longer than the recording drum 1 axially of the latter, it will serve the purpose only if the second suction unit 60 covers at least the movable range of the recording head 8, i.e. the image recording range of the recording head 8.

As shown in FIG. 7, the unit main body 62 is in the shape of a part cylinder having two curved portions 62a and 62b. The lower curved portion 62b (i.e. the curved portion closer to the recording head 8) extends only to a position distant from the peripheral surface of the recording drum 1. Consequently, the gas generating from the image recording medium 100 as a result of irradiation by the light beam from the recording head 8 can easily enter the unit main body 62. The upper curved portion 62a has a lower end thereof lying adjacent the peripheral surface of the recording drum 1 to be close to upper surfaces of the forward end clamps 2 or rear end clamps 3. Consequently, the gas generating from the image recording medium 100 and entering the unit main body 62 past the lower curved portion 62b will not leak from the unit main body 62 in the direction of rotation of the recording drum 1.

The unit main body 62 has curved inner surfaces not having indentations or projections, and thus the gas can flow easily and smoothly along the inner surfaces. That is, there is no element obstructive to gas flows. Only a small amount of gas can adhere to the inner surfaces of the unit main body 62. Further, the inner surfaces of the unit main body 62 are lined with film 62c detachably attached to the inner surfaces.

The unit main body 62 has an upper surface supported by the pair of support arms 61 and fixed to the bearings 12.

As shown in FIG. 8, the upper surface of the unit main body 62 has formed therein the opening 64 elongated axially of the recording drum 1. The gas generating from the image recording medium 100 includes components that solidify from gaseous state to jellied state (state of oil and fat) or powdered state. Therefore, jellied or powdered substances can adhere to portions exposed to the gas. The opening 64 for drawing air including the gas out of the unit main body 62 has a sufficiently large area so that the opening 64 will never be blocked up by the adhering substances.

Further, the second suction unit 60 has the taper portion 65. An exhaust pipe 78 is connected to the top of the taper portion 65. As shown in FIGS. 7 and 8, the taper portion 65 has an inside diameter gradually diminishing from the portion connected to the opening 64 toward the exhaust pipe 78.

The exhaust pipe 78 is connected a second vacuum pump 81 disposed outside the housing 15 of the image recording apparatus. The second vacuum pump 81 has a greater output than the first vacuum pump 79 noted hereinbefore. The second vacuum pump 81 sucks gases including the gas generating from the image recording medium 100, from the second suction unit 60 and, after filtering the gases through a filter 90, releases the gases to the atmosphere. The filter 90 is detachably attached to a delivery port, not shown, of the second vacuum pump 81.

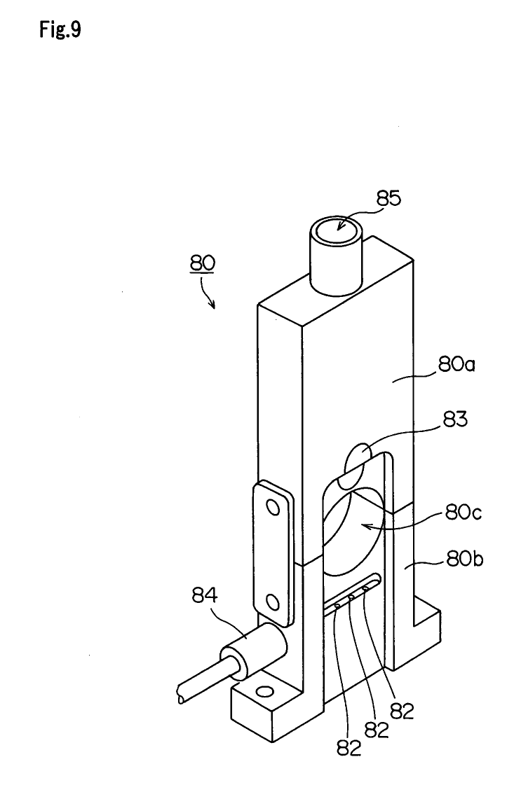

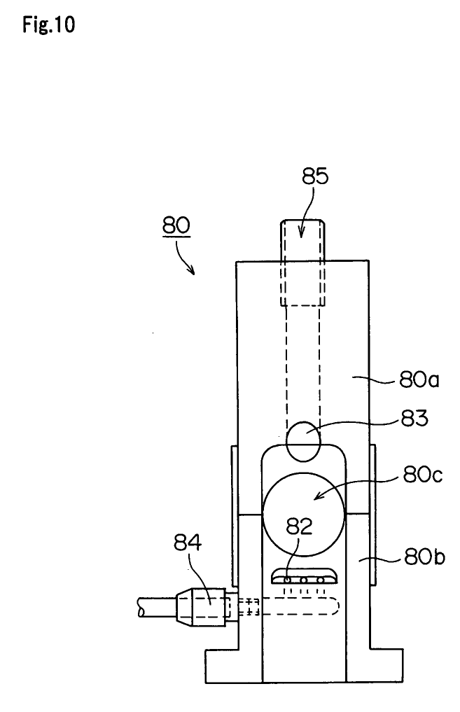

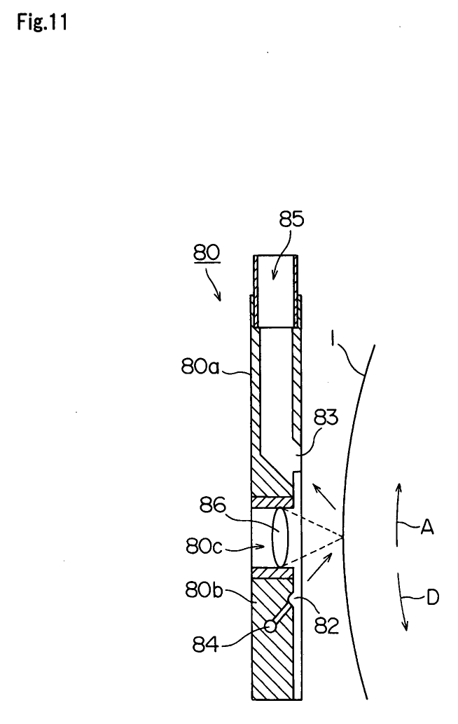

The gas diffusing suction unit 80 of the exposing head 8 will be described next. FIG. 9 is a perspective view of the gas diffusing suction unit 80. FIG. 10 is a front view and FIG. 11 is a view in vertical section thereof.

In these figures, the gas diffusing suction unit 80 includes an upper block 80a and a lower block 80b. A circular lens bore 80c is formed in a connection between the upper block 80a and lower block 80b. The objective lens 86 is mounted in the lens bore 80c. The lens bore 80c is coaxial with the laser emitting bore 87 formed in the case 20 of the recording head 8.

The upper block 80a and lower block 80b are easily separable from each other. This facilitates adjustment, cleaning and changing of the objective lens 86.

The lower block 80b has a plurality of air jet ports 82 formed in a front surface thereof. The air jet ports 82 are in communication with the air supply port 84 formed in a side surface of the lower block 80b. These air jet ports 82 are arranged upstream with respect to the direction of rotation of the recording drum 1 when the recording drum 1 rotates in the direction of arrow A, and downstream with respect to the direction of rotation of the recording drum 1 when the recording drum 1 rotates in the direction of arrow D.

The air jet ports 82 are directed substantially to a position on the recording drum 1 irradiated by the laser light from the objective lens 86. As a result, the gas generated by irradiation of the laser light is diffused by air. An air curtain approximately semicircular about the position irradiated by the light beam is formed upstream or downstream thereof with respect to the direction of rotation of the recording drum 1, whereby the gas generating from the image recording medium 100 is prevented from spreading upstream or downstream with respect to the direction of rotation of the recording drum 1.

The upper block 80a has a gas suction opening 83 formed in a front surface thereof. The gas suction opening 83 is disposed downstream of the objective lens 86 with respect to the direction of rotation of the recording drum 1 when the recording drum 1 rotates in the direction of arrow A, and upstream of the objective lens 86 with respect to the direction of rotation of the recording drum 1 when the recording drum 1 rotates in the direction of arrow D. The gas suction opening 83 is directed substantially to the position on the recording drum 1 irradiated by the laser light from the objective lens 86. The gas suction opening 83 is in communication with a gas exhaust port 85 disposed in a top surface of the upper block 80a. Thus, the gas generated by irradiation of the laser light is sucked along with air.

The generation of gas from the image recording medium 100 in time of image recording and a state of collecting the gas will be described next with reference to FIG. 7.

First, a case of rotating the recording drum 1 at high speed will be described. In this case, the controller 122 rotates the recording drum 1 in the direction of arrow A shown in FIG. 7.

The light beam is emitted from the recording head 8 toward the image recording medium 100 to form an image at a point of irradiation P. Since the recording drum 1 with the image recording medium 100 mounted thereon rotates in the direction of arrow A at high speed, the gas generating from the image recording medium 100 mainly flows downstream with respect to the direction of rotation of the recording drum 1, and does not easily spread upstream with respect to the direction of rotation of the recording drum 1. Further, air is jetted from the air jet ports 82 in the direction of arrow B toward the point of irradiation P, whereby an air curtain approximately semicircular about the point of irradiation P is formed upstream thereof with respect to the direction of rotation of the recording drum 1. As a result, the gas can hardly diffuse from the point of irradiation P upstream with respect to the direction of rotation of the recording drum 1.

A large part of the gas is collected through the gas suction opening 83. However, when the image recording medium 100 is the type that generates a large quantity of gas, the gas may not be collected entirely through the gas suction opening 83. The second suction unit 60 complements the gas suction opening 83 by sucking the remaining gas. With the rotation of the recording drum 1, the forward end clamps 2 produce airflow as indicated by arrows C1, C2 and C3 around the recording drum 1. As described hereinbefore, the unit main body 62 of the second suction unit 60 is shaped to have the end of the lower curved portion 62b located distant from the peripheral surface of the recording drum 1. The gas can be collected efficiently even when airflow including the gas spread wide as indicated by arrows C1, C2 and C3.

Next, a case of rotating the recording drum 1 at low speed will be described. In this case, the controller 122 rotates the recording drum 1 in the direction of arrow D shown in FIG. 7.

In this case, since the recording drum 1 with the image recording medium 100 mounted thereon rotates in the direction of arrow D at low speed, little action takes place to cause the gas generating from the image recording medium 100 to flow downstream with respect to the direction of rotation of the recording drum 1. Further, air is jetted from the air jet ports 82 in the direction of arrow B toward the point of irradiation P, whereby an air curtain approximately semicircular about the point of irradiation P is formed upstream thereof with respect to the direction of rotation of the recording drum 1. As a result, the gas can hardly diffuse from the point of irradiation P downstream with respect to the direction of rotation of the recording drum 1. Thus, the gas is reliably prevented from contacting the image recording medium having an image recorded thereon.

A large part of the gas is collected through the gas suction opening 83. However, when the image recording medium 100 is the type that generates a large quantity of gas, the gas may not be collected entirely through the gas suction opening 83. In such a case, as in the foregoing case, the second suction unit 60 complements the gas suction opening 83 by sucking the remaining gas.

In the foregoing embodiment, the gas diffusing suction unit 80 has an exhaust pipe 77 in communication with the first vacuum pump 79. The exhaust pipe 77 has a filter, not shown, mounted thereon. The gas collected by the gas diffusing suction unit 80 is considered to include a large quantity of particulate gas components (dust) having a relatively large specific gravity. Preferably, therefore, the filter mounted on the exhaust pipe 77 has a coarse mesh. On the other hand, the gas collected by the second suction unit 60 is considered to include a large quantity of gas components having a relatively small specific gravity. Preferably, therefore, the filter 90 attached to the second vacuum pump 81 has a fine mesh. It is preferred that both the filters are easy to change.

In the foregoing embodiment, the gas in the housing 15 is sucked by the second vacuum pump 81 mainly through the second suction unit 60 and exhaust pipe 78, to be released to the ambient. The housing 15 is constructed gastight so that ambient air may be introduced only through the air intake 88. The air intake 88 needs to have a sufficient size so that the internal gas pressure of the housing 15 may not fall far below atmospheric pressure when the second vacuum pump 81 is operated. If the internal gas pressure of the housing 15 fell far below atmospheric pressure, ambient air from which foreign substances are not removed by the filter 89 could flow into the housing 15.

Thus, in the foregoing embodiment, ambient air is introduced into the housing 15 only through the air intake 88 having the filter 89 fitted therein. The second vacuum pump 81 discharges air from the housing 15 to the ambient through the filter 90. In this way, the interior of the housing 15 can be maintained clean. At the same time, the gas generating from the image recording medium 100 is not released to the ambient without being treated, thereby minimizing influence on working environment.

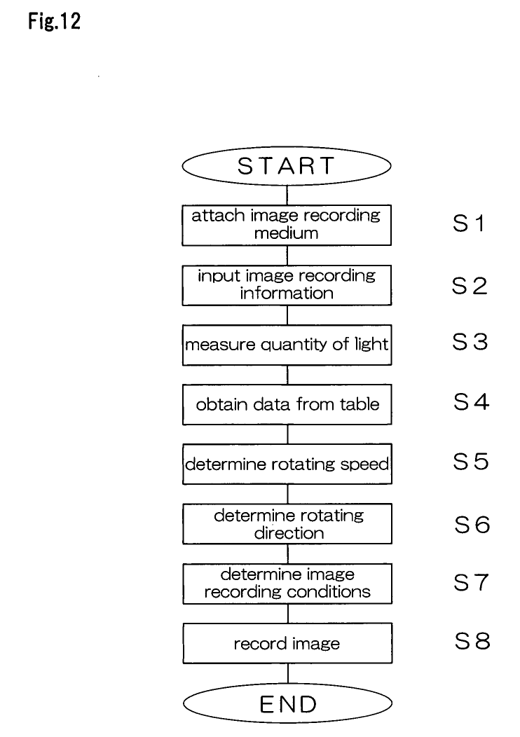

A recording operation of the above image recording apparatus for recording an image will be described next. FIG. 12 is a flow chart of the image recording operation.

When recording an image, the transport unit 9 first feeds the image recording medium 100. The image recording medium 100 is attached to the peripheral surface of the recording drum 1 by the forward end clamps 2 and rear end clamps 3 (step S1). Then, the input device 123 is used to input image recording information including the type of image recording medium 100 and a resolution in time of image recording (step S2).

The controller 122 measures, by means of the actinometric sensor 127, intensity of the light beam emitted from the recording head 8 (step S3). The intensity of the light beam may be measured only when image recording has been carried out a predetermined number of times.

Next, the controller 122 refers to the type of image recording medium 100 and the resolution in time of image recording inputted, and the intensity of the light beam measured, and obtains data from the table 14 (step S4).

Based on the data obtained, the controller 122 determines a rotating speed and a direction of rotation of the recording drum 1 (steps S5 and S6). At this time, the controller 122 functions as the rotating direction changing device of this invention.

As described hereinbefore, a direction of rotation of the recording drum 1 is determined from a rotating speed of the recording drum 1 at this time. However, a direction of rotation of the recording drum 1 may be determined by taking into account one or both of the type of image recording medium 100 and the resolution in time of image recording.

Generally, when the resolution in time of image recording is high, recording speed is fast in the primary scanning direction, and slow in the secondary scanning direction. This fact is considered in determining a direction of rotation of the recording drum 1.

Next, image recording conditions are determined based on the rotating speed and direction of rotation of the recording drum 1 (step S7). The image recording conditions include, for example, a relationship between recording position and image data based on an image recording start position and a spiral locus in time of recording the image.

Subsequently, image recording is carried out (Step S8). At this time, the controller 122 controls the motor 120 for rotating the recording drum 1, the motor 13 for secondary scanning, and the head drive circuit 125.

In the foregoing embodiment, the direction of air jetted from the air jet ports 82 toward the point of irradiation P is perpendicular to the direction of movement of the recording head 8 (i.e. the secondary scanning direction). The direction of gas suction by the gas suction opening 83 also is perpendicular to the direction of movement of the recording head 8 (secondary scanning direction). However, the direction of air jetted from the air jet ports 82 toward the point of irradiation P may extend downstream with respect to the direction of movement of the recording head 1, and the direction of gas suction by the gas suction opening 83 may also extend downstream with respect to the direction of movement of the recording head 1.

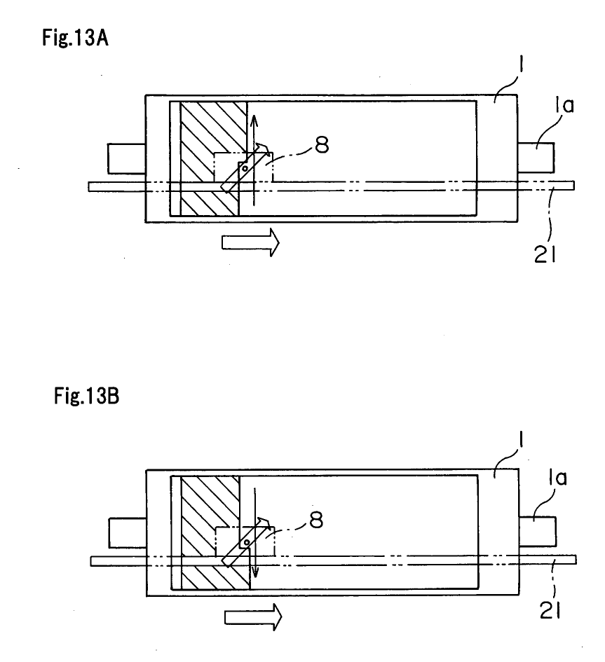

FIGS. 13A and 13B are explanatory views illustrating such an embodiment. FIG. 13A shows a state where the recording drum 1 is rotating in the direction of arrow A in FIG. 2. FIG. 13B shows a state where the recording drum 1 is rotating in the direction of arrow D in FIG. 2. The white arrows in these figures schematically indicate movement of the gas caused by the air jetting from the air jet ports 82 and the suction of the gas by the gas suction opening 83.

With this construction, the gas generating from the image recording medium 100 in time of image recording is effectively prevented from encroaching on a recorded image area shown in hatches in FIGS. 13A and 13B.

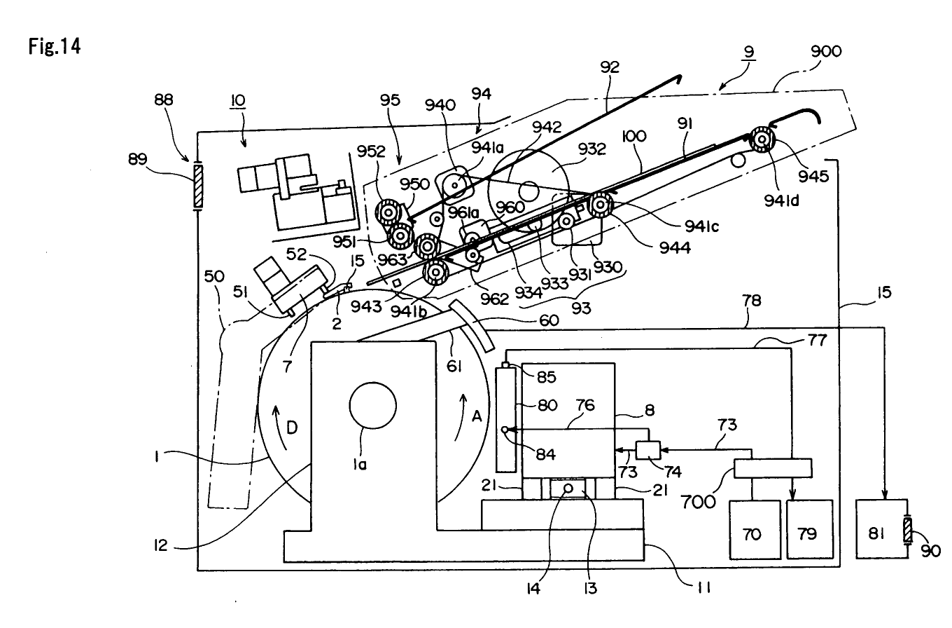

Another embodiment of this invention will be described next. FIG. 14 is a schematic view of an image recording apparatus in the second embodiment of this invention. Like reference numerals are used to identify like parts which are the same as in the first embodiment and will not be described again.

The image recording apparatus in the first embodiment is constructed to change the relationship between the direction of rotation of the recording drum 1 and the direction of gas jetting and suction by reversing the direction of rotation of the recording drum 1. The image recording apparatus in the second embodiment is constructed to change the relationship between the direction of rotation of the recording drum 1 and the direction of gas jetting and suction by exchanging the functions of the air jet ports 82 and gas suction opening 83.

Thus, the second embodiment provides a supply route switcher 700 disposed between the first vacuum pump 79 and exhaust pipe 77 and between the air supply pump 70 and feed pipe 73. The supply route switcher 700 serves to switch between a state of connecting the first vacuum pump 79 and exhaust pipe 77 and connecting air supply pump 70 and feed pipe 73 as in the first embodiment, and a state of connecting the first vacuum pump 79 and feed pipe 73 and connecting the air supply pump 70 and exhaust pipe 77. With this construction, air can be blown and gas can be sucked from both the air jet ports 82 and gas suction opening 83.

In the image recording apparatus in the second embodiment, when the recording drum 1 is rotated at high speed, the recording drum 1 with the image recording medium 100 mounted thereon is rotated in the direction of arrow A as in the first embodiment. Air is blown from the air jet ports 82 toward the point of irradiation P, and gas is sucked from the gas suction opening 83.

When the recording drum 1 is rotated at low speed, on the other hand, the recording drum 1 with the image recording medium 100 mounted thereon is rotated in the direction of arrow A, as distinct from the first embodiment. At this time, air is blown from the gas suction opening 83 toward the point of irradiation P, and gas is sucked from the air jet ports 82.

When this embodiment is employed, it is necessary to design the branch pipe 74 in such a way that air will not be blown into the recording head 8 when blown off from the gas suction opening 83.

In each of the embodiments described hereinbefore, the laser source 30 includes two laser units 31 and 32. Instead, this invention may be applied to an image recording apparatus using a multichannel light source having numerous semiconductor lasers arranged in the secondary scanning direction as described in Japanese Unexamined Patent Publication H11-10852 (1999) or Japanese Unexamined Patent Publication No. 2001-341344, for example.

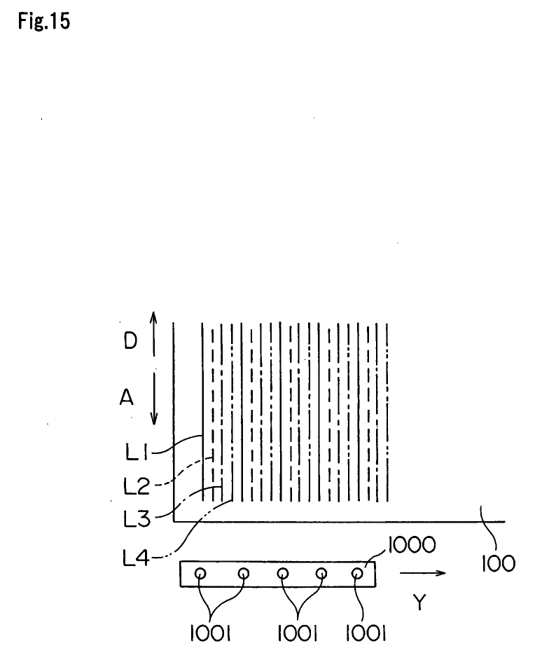

FIG. 15 is a schematic view showing such an embodiment.

This embodiment uses a recording head 1000 having numerous semiconductor lasers 1001 arranged therein. An image is recorded by moving the recording head 1000 in a direction of Y in FIG. 15 (secondary scanning direction), and rotating the recording drum 1 with the recording medium 100 in the direction of A or D.

In this embodiment, each semiconductor laser 1001 forms a scanning line shown in solid line L1 on the image recording medium 100 in time of a first rotation of the recording drum 1. Before the recording drum 1 makes a next rotation, the recording head 1000 is moved in the secondary scanning direction Y to shift each semiconductor laser 1001 to a position for forming a scanning line shown in chain line L2. Then, with the next rotation (second rotation) of the recording drum 1, the scanning line shown in chain line L2 is formed by each semiconductor laser 1001.

Before the recording drum 1 makes a further rotation, the recording head 1000 is moved in the secondary scanning direction Y to shift each semiconductor laser 1001 to a position for forming a scanning line shown in alternate long and short dash line L3. Then, with the further rotation (third rotation) of the recording drum 1, the scanning line shown in alternate long and short dash line L3 is formed by each semiconductor laser 1001.

Before the recording drum 1 makes a next rotation, the recording head 1000 is moved in the secondary scanning direction Y to shift each semiconductor laser 1001 to a position for forming a scanning line shown in two-dot chain line L4. Then, with the next rotation (fourth rotation) of the recording drum 1, the scanning line shown in two-dot chain line L4 is formed by each semiconductor laser 1001.

In this way, spaces between the scanning lines (scanning lines L1 shown in solid lines) formed in time of the first rotation of the recording drum 1 are filled by performing three main scans. As a result, a plurality of scanning lines are formed at equal intervals on the image recording medium 100, to complete an image recording operation.

In each of the embodiments described hereinbefore, deterioration of a recorded image due to gas is prevented regardless of the rotating speed of the recording drum 1, by changing the relationship between the direction of rotation of the recording drum 1 and the gas jetting and sucking direction according to the rotating speed of the recording drum 1. However, this invention is not limited to the above. The invention is applicable also to an image recording apparatus dedicated to an image recording medium of low sensitivity, for recording an image by rotating the recording drum 1 at low speed. In this case, the direction of rotation of the recording drum 1 may be fixed, with a gas jetted from a downstream position with respect to the direction of rotation of the recording drum 1, and sucked in an upstream position with respect to the direction of rotation of the recording drum 1.

The foregoing embodiments disclose the construction for enabling selection of a direction of rotation of the recording drum 1, with the gas diffusing suction unit 80 forming an airflow directed upward. However, it is possible to employ a construction for enabling selection of a direction of rotation of the recording drum 1, with the gas diffusing suction unit 80 forming an airflow directed downward.

A further embodiment of this invention will particularly be described hereinafter.

The image recording medium 100 used in the first embodiment, when irradiated by the laser beam as light beam, generates dust with 60 to 70 μm particle size, and with density of about 2.5 g in weight per cubic centimeter. The recording drum 1 is 270 mm in diameter. The gas diffusing suction unit 80 used therein produces an airflow moving upward as shown in FIG. 11. The flow rate of air caused by the gas diffusing suction unit 80 at this time is 12 litres per minute.

It has been found that, under such conditions, it is effective to switch the direction of rotation of the recording drum 1 when the rotating speed of the recording drum 1 is about 300 rpm. The 270 mm diameter of the recording drum 1 corresponds to a peripheral velocity of 4241 mm/s at the rotating speed of 300 rpm.

When the recording drum 1 is rotated in the direction of arrow A in FIG. 11, at the rotating speed of 300 rpm or higher, dust soars at high speed due to a multiplier effect of an airflow produced peripherally of the recording drum 1 and an airflow produced by the gas diffusing suction unit 80. The air including this dust is collected through the gas suction opening 83.

On the other hand, when the recording drum 1 is rotated in the direction of arrow D in FIG. 11, at the rotating speed of 300 rpm or higher, the airflow produced by rotation of the recording drum 1 cannot be used for collecting dust. Therefore, when rotating the recording drum 1 at the rotating speed of 300 rpm or higher, it is preferable to rotate the recording drum 1 in the direction of arrow A in FIG. 11.

On the other hand, when the rotating speed of the recording drum 1 is less than 300 rpm, the airflow produced by rotation of the recording drum 1 is very weak. Therefore, dust will not be collected quickly through the gas suction opening 83 even if the recording drum 1 is rotated in the direction of arrow A in FIG. 11, to coincide with the direction of airflow set by action of the gas diffusing suction unit 80. Thus, the dust will stagnate over the recorded image area of the recording medium 100 for a long time, to impart an adverse influence on the recorded area.

When the recording drum 1 is rotated in the direction of arrow D in FIG. 11, counter to the direction of airflow set by action of the gas diffusing suction unit 80, the dust will not flow over the recorded image area of the image recording medium 100. Even if collecting the dust takes some time, the recorded area is not adversely affected by the dust. Therefore, when rotating the recording drum 1 at a rotating speed less than 300 rpm, it is preferable to rotate the recording drum 1 in the direction of arrow D in FIG. 11.

The image recording medium 100 used in the second embodiment, when irradiated by the laser beam as light beam, generates dust with about 0.3 μm particle size, and with density of about 1.8 g in weight per cubic centimeter. The recording drum 1 is 270 mm in diameter. The flow rate of air caused by the gas diffusing suction unit 80 is 20 litres per minute. The 270 mm diameter of the recording drum 1 corresponds to a peripheral velocity of 2500 mm/s at the rotating speed of 180 rpm.

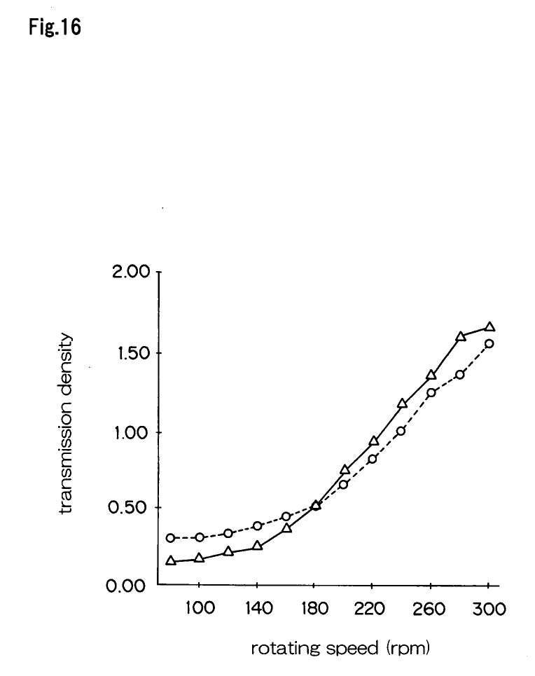

FIG. 16 is a graph showing a relationship between rotating speed of the recording drum 1 and transmission density of the image recording medium 100 with an image recorded then. In this graph, the broken line represents the case of rotating the recording drum 1 in the direction of arrow A in FIG. 11, while the solid line represents the case of rotating the recording drum 1 in the direction of arrow D shown in FIG. 11.

When dust stagnates over the recorded image area of the image recording medium 100 to have an adverse influence on the recorded area, the transmission density of the image recording medium 100 becomes high. As seen from FIG. 16, under such conditions, a desirable direction of rotation of the recording drum 1 switches when the rotating speed of the recording drum 1 is about 180 rpm.

That is, when rotating the recording drum 1 at the rotating speed of 180 rpm or higher, it is preferable to rotate the recording drum 1 in the direction of arrow A in FIG. 11, represented by the broken line. When rotating the recording drum 1 at the rotating speed below 180 rpm, it is preferable to rotate the recording drum 1 in the direction of arrow D in FIG. 11, represented by the solid line.

This invention may be embodied in other specific forms without departing from the spirit or essential attributes thereof and, accordingly, reference should be made to the appended claims, rather than to the foregoing specification, as indicating the scope of the invention.

This application claims priority benefit under 35 U.S.C. Section 119 of Japanese Patent Application No. 2006-087666 filed in the Japanese Patent Office on Mar. 28, 2006 and Application No. 2007-014656 filed in the Japanese Patent Office on Jan. 25, 2007 the entire disclosure of which is incorporated herein by reference.

What is claimed is:

1. An image recording apparatus comprising:
a recording drum for supporting an image recording medium mounted on a peripheral surface thereof;
a rotating device for rotating said recording drum in a first direction about an axis thereof;
a recording head for emitting a light beam to said image recording medium mounted on the peripheral surface of said recording drum;
a recording head moving device for moving said recording head in a direction parallel to the axis of said recording drum;
a jetting device movable with said recording head axially of said recording drum, for jetting a gas from a downstream position with respect to the direction of rotation of said recording drum toward a position of said image recording medium irradiated by said light beam, thereby to diffuse a gas generating from said image recording medium as a result of irradiation by the light beam, upstream with respect to the direction of rotation of said recording drum; and
a suction device movable with said recording head axially of said recording drum, for sucking gases present adjacent the position of said image recording medium irradiated by said light beam from an upstream position with respect to the direction of rotation of said recording drum, thereby to suck the gas generating from said image recording medium as a result of irradiation by the light beam and diffused by said jetting device, from the upstream position with respect to the direction of rotation of said recording drum.

2. An image recording apparatus as defined in claim 1, wherein said jetting device is arranged to jet the gas downstream with respect to the direction of movement of said recording head, and said suction device is arranged to such the gas downstream with respect to the direction of movement of said recording head.

3. An image recording apparatus as defined in claim 1, further comprising a rotating direction changing device for changing the direction of rotation of said recording drum by said rotating device from said first direction of rotation to an opposite direction.

4. An image recording apparatus as defined in claim 3, wherein said rotating direction changing device is arranged to change the direction of rotation of said recording drum by said rotating device according to a rotating speed of said recording drum.

5. An image recording apparatus as defined in claim 3, wherein said rotating direction changing device is arranged to change the direction of rotation of said recording drum by said rotating device according to a type of said image recording medium mounted on said recording drum.

6. An image recording apparatus as defined in claim 3, wherein said rotating direction changing device is arranged to change the direction of rotation of said recording drum by said rotating device according to a resolution in time of image recording.

7. An image recording apparatus as defined in claim 3, wherein:
the rotating speed of said recording drum by said rotating device is selectable from at least two, low and high, speeds; and
said rotating direction changing device is arranged, when rotating said recording drum at the low speed, to rotate said recording drum in a direction for enabling said jetting device to diffuse the gas generating from said image recording medium upstream with respect to the direction of rotation of said recording drum, and when rotating said recording drum at the high speed, to rotate said recording drum in a direction for enabling said jetting device to diffuse the gas generating from said image recording medium downstream with respect to the direction of rotation of said recording drum.

8. An image recording apparatus comprising:
a recording drum for supporting an image recording medium mounted on a peripheral surface thereof;
a rotating device for rotating said recording drum about an axis thereof;
a recording head for emitting a light beam to said image recording medium mounted on the peripheral surface of said recording drum;
a recording head moving device for moving said recording head in a direction parallel to the axis of said recording drum;
a jetting device movable with said recording head axially of said recording drum, for jetting a gas selectively from one of an upstream position and a downstream position with respect to the direction of rotation of said recording drum toward a position of said image recording medium irradiated by said light beam, thereby to diffuse a gas generating from said image recording medium as a result of irradiation by the light beam, upstream or downstream with respect to the direction of rotation of said recording drum;
a suction device movable with said recording head axially of said recording drum, for sucking gases present adjacent the position of said image recording medium irradiated by said light beam selectively from one of an upstream position and a downstream position with respect to the direction of rotation of said recording drum, thereby to suck the gas generating from said image recording medium as a result of irradiation by the light beam and diffused by said jetting device, from the one of the upstream position and the upstream position with respect to the direction of rotation of said recording drum; and
a jetting/sucking direction changing device for changing a gas jetting direction of said jetting device and a gas sucking direction of said suction device, as maintained counter to each other.
